(19) United States
(12) Patent Application Publication
(10) Pub. No.: US 2026/0158532 A1
(43) Pub. Date: Jun. 11, 2026

(54) HARMLESS-TREATMENT CHEMICAL AGENT FOR PHOSPHOGYPSUM AND ENGINEERING APPLICATION METHOD THEREOF

(71) Applicant: BCEG ENVIRONMENTAL REMEDIATION CO., LTD., Beijing (CN)

(72) Inventors: Shaoguo KANG, Beijing (CN); Peng LIU, Beijing (CN); Bosheng ZHOU, Kunming (CN); Jiaoyan KONG, Beijing (CN); Liping LIU, Beijing (CN); Songlin YANG, Beijing (CN); Li QIN, Beijing (CN); Xin LI, Beijing (CN); Yuanwen LIU, Beijing (CN); Shupeng LI, Beijing (CN); Lili GUO, Beijing (CN)

(21) Appl. No.: 19/446,085

(22) Filed: Jan. 12, 2026

Related U.S. Application Data
(63) Continuation of application No. PCT/CN2024/075183, filed on Feb. 1, 2024.

(30) Foreign Application Priority Data
Jul. 12, 2023 (CN) 202310848416.8

(51) Int. Cl. B09B 3/70; B09B 3/30

(52) U.S. Cl. CPC B09B 3/70; B09B 3/30

(57) ABSTRACT

The present invention belongs to the technical field of solid waste treatment and disposal, concerning a harmless-treatment chemical agent for phosphogypsum and an engineering application method thereof. The chemical agent consists of a powder component and a liquid component, the powder component consists of an alkaline component and talc powder, and the alkaline component is at least one of calcium oxide, magnesium oxide, calcium hydroxide and magnesium hydroxide; the liquid component is an aqueous solution of at least one of a soluble iron salt, a soluble aluminum salt and a soluble calcium salt. The engineering application method comprises: S1 breaking and sieving phosphogypsum into a particle size of 1-5 mm, meanwhile adjusting a content of adsorbed water to 5-10%; S2 mixing evenly the pretreated phosphogypsum with the powder component; S3 adding a liquid component and adjusting a content of adsorbed water to 12-20%; and S4 maintenance and preparation for inspection. It is possible to make full use of the synergistic effects of the components by combining the powder component with the liquid component, and realize a more environmentally friendly and efficient engineering application by adding and mixing the powder and liquid components step by step.

### FIELD OF THE INVENTION

The present invention relates to the technical field of solid waste treatment and disposal, in particular to a harmless-treatment chemical agent for phosphogypsum and an engineering application method thereof.

### BACKGROUND OF THE INVENTION

Phosphoric acid, as a main product from phosphorus chemical industry, is one of the primary raw materials for phosphate fertilizers and lithium iron phosphate batteries, and it is crucial for nation in grain security and energy security. The main process for phosphoric acid production is classified into the wet process and the pyrometallurgical process. The wet process is lower than one-quarter of the pyrometallurgical process in costs and prevails for producing phosphoric acid. A large amount of by-product phosphogypsum will be produced in the wet process for producing phosphoric acid. According to statistics, the course of producing 1 ton of phosphoric acid will bring out approximately 4 to 5 tons of phosphogypsum. Currently, the phosphogypsum stockpiled in all slag yards in China totals 250 to 280 million tons. In addition, about 70 million tons of new phosphogypsum are still discharged every year. The phosphogypsum mainly contains calcium sulfate dihydrate, and secondly contains impurities such as Al, Fe, Mg, Si, Ca, as well as pollutants like phosphorus, fluorine, and heavy metals.

At present, the way of typically storing up phosphogypsum acts as a main measure for treatment in China. Due to a high content of substances such as easily mobile soluble phosphorus and fluorine, acid-insoluble matter, and heavy metals, these harmful substances continuously transform and migrate during the storage of phosphogypsum, causing long-term pollution to the environment within and around the zone for stockpiling phosphogypsum.

In addition to stockpiling, currently the way of utilizing phosphogypsum also includes comprehensive utilization approaches such as producing building materials, serving as a cement retarder, and producing sulfuric acid. However, for the reasons such as high costs, unstable product quality, and constraints on distribution range caused by transportation costs, the aforementioned comprehensive utilization approaches can only consume a small amount of phosphogypsum and cannot fundamentally solve the problem of consuming phosphogypsum in low efficiency. After harmless treatment, the way of using phosphogypsum as an engineering material for land remediation, backfill in abandoned mines, and filling in underground mining areas is one of the approaches to achieve utilizing phosphogypsum in large-scale.

The way of using phosphogypsum as the above-mentioned engineering material requires meeting requirements for environmental protection. According to existing environmental technology standards, the content of phosphorus, fluorine, and heavy metals in phosphogypsum usually does not meet the standard limit and needs to undergo harmless treatment before it can be used. At present, the harmless treatment method for phosphogypsum includes the processes of high-temperature calcination, water washing, and chemical passivation. Among them, the high-temperature calcination will consume a large amount of heat, have high energy costs, and discharge a big amount of carbon dioxide, in inconsistence with the current national policy that promotes carbon reduction, so it does not have a prospect of engineering application. The water-washing method consumes a large amount of water, and highly-polluted wastewater generated after washing requires treatment and dischargement; therefore, the method poses problems such as high costs, big water consumption, and constraints on dischargement pathways, and is only applied in small-scale in the field of using phosphogypsum to produce high-value-added building materials.

The chemical passivation method converts easily mobile pollutants into less mobile substances by adding passivation chemicals to phosphogypsum, so as to achieve harmlessly treating phosphogypsum. After harmless treatment, a route for utilizing phosphogypsum can be greatly expanded. However, the chemical passivation method poses problems such as lack of highly effective passivation chemicals, difficulty in controlling airborne dust during implementation, imperfection of mixing solids with solids at a low dosing ratio, and insufficient mixing, which posing limitations on the large-scale application for passivating phosphogypsum.

### SUMMARY OF THE INVENTION

An objective of the present invention is to provide a harmless-treatment chemical agent for phosphogypsum and an engineering application method thereof, so as to solve at least one of the problems such as lack of highly effective passivation chemicals, difficulty in controlling airborne dust during implementation, imperfection of mixing solids with solids at a low dosing ratio, and insufficient mixing in the prior art.

In order to achieve the above objective, the present invention adopts the following technical solution.

A harmless-treatment chemical agent for phosphogypsum consists of a powder component and a liquid component, wherein the powder component consists of an alkaline component and talc powder, and the alkaline component is at least one of calcium oxide, magnesium oxide, calcium hydroxide and magnesium hydroxide; the liquid component is an aqueous solution of at least one of a soluble iron salt, a soluble aluminum salt and a soluble calcium salt.

In the chemical agent, each alkaline component in the powder component is an alkaline substance, used to adjust the PH of phosphogypsum from less than 7 to 7 until lightly more than 7.

In the chemical agent, the talc powder serves as part of the powder component due to its lubricity and hydrophobicity, and performs a function of reducing agglomeration of phosphogypsum and improving dispersibility of phosphogypsum by way of forming a coating film and a hydrophobic layer on the surface of phosphogypsum.

In the chemical agent, why to select an active ingredient in the liquid component from a soluble iron salt, a soluble aluminum salt, and a soluble calcium salt attributes to the fact that the iron, aluminum, and calcium in the active ingredient can react with phosphate and fluoride ions in phosphogypsum to form stable precipitates, performing a function of reducing mobility of harmful components and achieving harmless treatment to harmful components like phosphorus and fluorine, by way of forming low-solubility substances such as calcium fluoride, calcium phosphate, ferric phosphate, and aluminum phosphate.

As a selective embodiment, the soluble aluminum salt includes at least one of aluminum sulfate, aluminum chloride, poly-aluminum chloride and the like.

As a selective embodiment, the soluble iron salt includes at least one of ferric sulfate, ferric chloride, ferrous sulfate, poly-ferric sulfate and the like.

As a selective embodiment, the soluble calcium salt is calcium chloride.

Among the above components, the calcium oxide, the magnesium oxide, the calcium hydroxide, and the magnesium hydroxide are in form of powder. Preferably, a divergence between distributions of their particle size and the particle size of the phosphogypsum to be treated is not more than +5%, and the content of active ingredients of the alkaline component is not less than 80%, in other words, in cases of using raw materials containing calcium oxide, magnesium oxide, calcium hydroxide, and/or magnesium hydroxide, the content of calcium oxide, magnesium oxide, calcium hydroxide, and/or magnesium hydroxide in the raw material is not less than 80%.

Among the above components, the talc powder is in form of powder, with preferred fineness of not less than 400 mesh.

Among the above components, the soluble iron salt, the aluminum salt, and the calcium salt may be an industrial-class product, and the content of pollutants should meet requirements of each product and a limit standard to pollutants in soil.

Preferably, in the harmless-treatment chemical agent for phosphogypsum, in the powder component, a weight ratio of the alkaline component is 0.2%˜1.0%, that is, the weight ratio of the alkaline component in proportion of the phosphogypsum to be treated is 0.2%˜1.0% (for example, 0.3%, 0.4%, 0.5%, 0.6%, 0.7%, 0.8%, 0.9%, etc.); a weight ratio of the talc powder is 0.1%˜0.6%, that is, the weight ratio of the talc powder in proportion of the phosphogypsum to be treated is 0.1%˜0.6% (for example, 0.2%, 0.3%, 0.4%, 0.5%, etc.); a weight ratio of the liquid component is 0.2%˜0.6%, that is, the weight ratio of the liquid component calculated as solid in proportion of the phosphogypsum to be treated is 0.2%˜0.6% (for example, 0.25%, 0.30%, 0.40%, 0.50%, 0.55%, etc.).

Preferably, in the powder component, a weight ratio of the alkaline component in proportion of the talc powder is 2˜5:1.

Preferably, the powder component consists of calcium oxide with a weight ratio of 0.40%, magnesium oxide with a weight ratio of 0.10%, and talc powder with a weight ratio of 0.10%; the liquid component consists of aluminum sulfate with a weight ratio of 0.15% and ferric chloride with a weight ratio of 0.10%.

Preferably, the powder component consists of calcium oxide with a ratio of 0.48% and talc powder with a weight ratio of 0.12%; the liquid component is polymeric alumina with a weight ratio of 0.40%.

Preferably, the powder component consists of calcium oxide with a weight ratio of 0.40% and talc powder with a weight ratio of 0.20%; the liquid component consists of poly-ferric chloride with a weight ratio of 0.10% and ferrous sulfate with a weight ratio of 0.20%.

An engineering application method of a harmless-treatment chemical agent for phosphogypsum, comprising:
S1 a step of pretreating Phosphogypsum, including the processes of breaking and sieving phosphogypsum into a particle size of 1-5 mm, meanwhile adjusting a content of adsorbed water to 5-10%, so as to obtain pretreated phosphogypsum;
S2 a step of adding a powder component, including the process of mixing evenly the pretreated phosphogypsum obtained in step S1 with the powder component of the harmless-treatment chemical agent for phosphogypsum mentioned above, so as to obtain a mixture;
S3 a step of adding a liquid component, including the processes of adding the liquid component of the harmless-treatment chemical agent for phosphogypsum mentioned above to the mixture obtained in step S2, and adjusting a content of adsorbed water to 12-20%, so as to obtain a material; and
S4 a step of maintenance and preparation for inspection, including the processes of piling the material obtained in step S3 for maintenance and maintaining moisture of the material to enable sufficient reaction, then carrying out comprehensive utilization as needed after achievability to a standard.

In step S1, oversized particles of phosphogypsum that easily make the material uneven, will further influence an effect for harmless treatment; therefor, the smaller the particle size of phosphogypsum, the better, but costs for processing become higher. Considering all factors, the particle size of the broken and sieved phosphogypsum is limited to 1-5 mm (for example, 2 mm, 3 mm, 4 mm, etc.). The purpose of adjusting a content of absorbed water to ensure that powder parts can be mixed evenly; therefore, the lower the content, the better; however, on one hand, if the content is too low, it easy to increase costs for processing; on other hand, if the content is too high, it is easy for powder to agglomerate and mix unevenly. Considering all factors, the content of absorbed water is limited to 5-10% (for example, 6%, 7%, 8%, 9%, etc.).

As a selective embodiment, in step S1, a device for broking phosphogypsum may be a jaw crusher, a cone crusher, a gyratory crusher, a hammer-type crusher, a roller-type crusher, a counterattack crusher, an impact crusher and the like.

As a selective embodiment, in step S1, a device for sieving phosphogypsum may be a fixed sieve, a rotary sieve, a vibrating sieve and the like.

As a selective embodiment, in step S2, a device for mixing evenly the pretreated phosphogypsum obtained in step S1 with the powder component of the harmless-treatment chemical agent for phosphogypsum mentioned above may be equipment that can continuously or intermittently operates, such as a twin-screw conical mixer, a horizontal ribbon screw mixer, a three-dimensional shaker mixer, a twin-shaft mixer, a concrete mixer, a pipeline mixer and the like.

In step S3, it is necessary to pay attention on adjusting the content of absorbed water in the material to 12-20% (for example, 13%, 14%, 15%, 16%, 17%, 18%, 19%, etc.). Water is a prerequisite for the reaction; however, if the content is high, the reaction proceeds quickly, but an excessively high content may cause leachate, increasing costs for water treatment, raising the possibility of secondary pollution and expenses for water. If the content is too low, the reaction is very slow or may not occur at all.

As a selective embodiment, in step S3, the process of adding the liquid component of the harmless-treatment chemical agent for phosphogypsum mentioned above to the mixture obtained in step S2 is executed by means of spraying. For example, a spray device may be installed at an appropriate position in a discharge zone such as a conveyor belt or a chute of mixing equipment. During discharging or transferring the mixture obtained in step S2, the liquid component of the harmless-treatment chemical agent for phosphogypsum mentioned above is added to the mixture, so the way of spraying performs a good dust-proof function.

As a selective embodiment, in step S4, the surface of the material obtained in step S3 is coated with a layer of matter, which may be a plastic film, a HDPE film, a non-woven fabric or a plant straw, and can prevent moisture in the stacked material from evaporating and provide a good reaction environment.

As a selective embodiment, in step S4, the process of piling the material is executed for 2-14 days, preferably 3-7 days.

Compared with the prior art, the technical solution of the present invention has the following beneficial effects.
1. By way of compounding multiple components and dividing them into a powder component and a liquid component based on their solubility and compatibility, and exerting a synergistic effect of three components, namely a pH adjusting component, a lubrication component, and a passivation component that included in the harmless-treatment chemical agent for phosphogypsum provided by the present invention, it is possible for the chemical agent to comprehensively utilize its properties of adjusting pH, lubrication and dispersion, and high-efficiency passivation to enable it to be efficiently and highly evenly mixed.
2. By way of optimizing the processes of adding and mixing chemical components and adding the powder component and the liquid component step by step, the present invention achieves stepwise adjusting a moisture content, controlling mixing uniformity, and preventing airborne dust during an engineering implementation process, enables a more environmentally friendly and high-efficient engineering application, and makes it possible to more effectively passivating phosphogypsum through addition at lower ratio.
3. By way of applying the technical solution of the present invention to the harmless treatment for phosphogypsum, it is possible to lower a radio of adding passivation components, control airborne dust during construction, and achieve efficiently mixing solids with solids at a low ratio; therefore, the technical solution is an efficient and environmentally friendly technology system for the harmless treatment for phosphogypsum.

### BRIEF DESCRIPTION OF THE DRAWINGS

FIG. 1 is a flowchart of the engineering application method of the harmless treatment chemical agent for phosphogypsum according to the present invention.

FIG. 2 shows SEM images of phosphogypsum before and after adding the powder component and the liquid component in Example 1 of the present invention, where A2 is a SEM image of phosphogypsum before adding the components, and B2 is a SEM image of phosphogypsum after adding the components.

FIG. 3 is a picture showing situations of stirring and agglomerating phosphogypsum at different water content rate in Example 4 of the present invention, where the left picture shows the situation of evenly mixing phosphogypsum at a low water content rate (9.24%); the middle picture shows the situation of agglomerating phosphogypsum after mixing at a medium water content rate (19.87%); and the right picture shows agglomerating and bleeding water after mixing at a high water content rate (26.32%).

### DETAILED DESCRIPTION OF SOME EMBODIMENTS

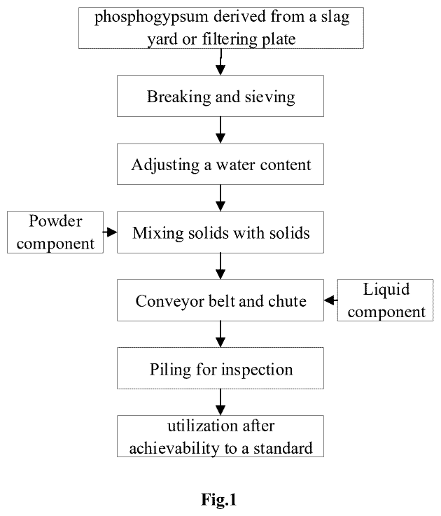

FIG. 1 is a flowchart of the engineering application method of the harmless treatment chemical agent for phosphogypsum according to a preferred embodiment of the present invention. The method includes the following steps.
S1 A step of pretreating Phosphogypsum, including the processes of breaking and sieving phosphogypsum into a particle size of 1-5 mm, meanwhile adjusting a content of adsorbed water to 5-10%, so as to obtain pretreated phosphogypsum.
S2 A step of adding a powder component, including the processes of stepwise adding a passivation component in the pretreated phosphogypsum obtained in step S1, that is, firstly adding a powder component, next evenly mixing by means of a mixer, so as to obtain a mixture.
S3 A step of adding a liquid component, including the processes of arranging a spray device at an appropriate position in a discharge zone such as a conveyor belt or a chute of mixing equipment, then adding a liquid component to the mixture obtained in step S2 by spraying, and adjusting a content of adsorbed water to 12-20% and while performing a function of reducing dust, so as to obtain a material.
S4 A step of maintenance and preparation for inspection, including the processes of piling the material obtained in step S3 for inspection after the above two-step chemical passivation, then covering the material with a layer of matter, which may be a plastic film, a HDPE film, a non-woven fabric, a plant straw and the like to maintain moisture of the material to enable sufficient reaction, then carrying out comprehensive utilization as needed after achievability to a standard.

We shall further describe the content of the present invention in details as follows in combination with some examples. The protection scope of the present invention includes but is not limited to the following examples.

For experimental steps or conditions not specified in the examples, we can understand their details with reference to conventional procedures or conditions as described in relevant literatures in the field.

Unless otherwise specified, all reagents and raw materials used in the examples are commercially available products.

### Example 1

In this example, phosphogypsum derived from a slag yard in Yunnan is used as a raw material to be treated for harmlessness by stepwise adding a powder component and a liquid component both serving passivation chemicals, among them, the powder component is a combination of calcium oxide with a weight ratio of 0.40%, magnesium oxide with a weight ratio of 0.10%, and talc powder with a weight ratio of 0.10%, based on 100 percent by weight of phosphogypsum; and the liquid component is a combination of aluminum sulfate with a weight ratio of 0.15% and ferric chloride with a weight ratio of 0.10% (each calculated as solid) based on 100 percent by weight of phosphogypsum.

The passivation chemicals are added in order of firstly adding the powder component then adding the liquid component. Before adding the powder component, the phosphogypsum is sieved and pretreated to a particle size of less than 3 mm, and its moisture content is adjusted to 8% by spreading and sun-drying. The powder component is mixed uniformly with the raw materials by means of an industrial dual-shaft mixer. The liquid component is added at a discharge outlet of equipment by spaying in a counter-direction, and the moisture content after spraying is 18%. The phosphogypsum is piling stored for inspection after harmless treatment, and covered with a simple plastic film to retain the material's moisture content.

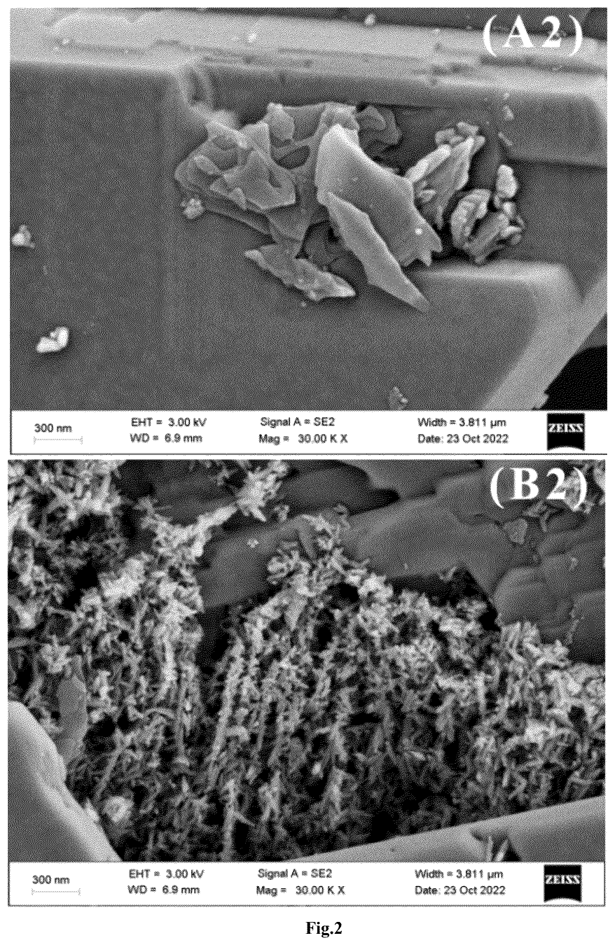

FIG. 2 shows SEM images of phosphogypsum before and after adding the powder component and the liquid component in Example 1 of the present invention, where A2 is a SEM image of phosphogypsum before adding the components, and B2 is a SEM image of phosphogypsum after adding the components. From FIG. 2, we find that the addition of harmless agents destroys a plate-shaped crystal structure of phosphogypsum, and soluble calcium, soluble iron, soluble aluminum, and other elements in the chemicals combine with phosphorus and fluorine to form new particulate substances.

In this example, a harmlessness effect of phosphogypsum is shown in Table 1. A testing medium is leachate prepared from the material according to <Toxicity Leaching Procedure for Solid Wastes-Horizontal Shaking Method> (HJ 557-2010).

TABLE 1
Harmlessness Effect of Phosphogypsum derived
from Liushujing slag yard (Unit: mg/L)

| Material | pH (unitless) | Phosphate | Fluoride |
|---|---|---|---|
| Phosphogypsum | 3.85 | 36.40 | 42.58 |
| Harmless phosphogypsum | 8.23 | 0.076 | 3.23 |

From Table 1, we find that after adding the chemicals, the phosphogypsum's leachate changes from acidic to alkaline. The concentration of phosphate declines by 99.8%, and the concentration of fluoride declines by 92.4%. All indicators in the leachate in the phosphogypsum treated for harmlessness are below the limit values specified in the <Integrated Wastewater Discharge Standard> (GB 8978-1996).

### Example 2

The phosphogypsum used in this example is derived from slag storage of a chemical enterprise and has an initial moisture content of 9.2%. Before implementation, the phosphogypsum is firstly sieved through a 10-mesh sieve and then mixed evenly by an excavator. The phosphogypsum is mixed with chemicals by using a concrete mixer with a hopper capacity of 0.5 tons.

In this example, the passivation chemical agent consists of a powder component and a liquid component. The powder component is obtained by evenly mixing calcium oxide with talc powder at a weight ratio of 4:1, and the liquid component is a poly-aluminum chloride solution.

We shall use an excavator to load the phosphogypsum into a feeding hopper of a concrete mixer, and add the powder component into the feeding hopper according to a weight ratio of 0.6%. The Phosphogypsum and the powder component enter a drum through the feeding hopper, and a motor and a reducer drive the mixing drum to rotated and mix them, then with the aid of a hydraulic system a mixture pushed out of the mixing drum. A spraying system is installed at a discharge outlet to spray the liquid component at a weight ratio of 0.4% (calculated as solid poly-aluminum chloride). During an unloading process, spraying is carried out manually. After spraying, the moisture content of the phosphogypsum is 16.7%.

We shall transfer the materials evenly mixed by the concrete mixer to an inspection area to form a pile, then cover its top with a HDPE film. After maintenance, then take three parallel samples from the pile on the 2^{nd} day, the 7^{th} day, and the 14^{th} day, next test the leachate of the sample materials according to <Toxicity Leaching Procedure for Solid Wastes-Horizontal Shaking Method> (HJ 557-2010). The test results of some samples are shown in Table 2.

TABLE 2
Pollutant content in the leachate of the material obtained
by treating phosphogypsum for harmlessness in Example 2

| | | | Phosphate (as | Fluoride |
|---|---|---|---|---|
| Sample | | pH | P) (mg/L) | (mg/L) |
| Initial concentration | | 3.79 | 115.51 | 19.48 |
| Reaction for | Sample after mixing 1 | 9.11 | 0.052 | 1.58 |
| 2 d | Sample after mixing 2 | 8.95 | 0.074 | 1.74 |
| | Sample after mixing 3 | 9.02 | 0.058 | 1.64 |
| Reaction for | Sample after mixing 4 | 8.11 | 0.059 | 1.39 |
| 7 d | Sample after mixing 5 | 8.42 | 0.082 | 1.14 |
| | Sample after mixing 6 | 8.94 | 0.044 | 1.19 |
| Reaction for | Sample after mixing 7 | 7.59 | 0.076 | 0.95 |
| 14 d | Sample after mixing 8 | 7.87 | 0.084 | 0.78 |
| | Sample after mixing 9 | 7.63 | 0.067 | 0.80 |

From Table 2, we can find after adding chemicals the leachate of phosphogypsum turns from acidic to alkaline on the 2^{nd} day, in the leachate generated from the sample on the 7^{th} day after reaction the concentration of the phosphate declines by 99.9% and the concentration of the fluoride declines by 93.6%. In the harmless phosphogypsum, all indicators are below the limit values specified in <Integrated Wastewater Discharge Standard> (GB 8978-1996).

### Example 3

In this example, we choose phosphogypsum that has been aged and dried for more than 6 months stored in a phosphate chemical slag yard, then excavate the material of 10 tons from a surface layer to a depth of 1 meter, obtaining of material, next sieve the material by using a 10-mesh stainless steel sieve to remove big agglomerated particles, while performing preliminary mixing and sun-drying pretreatment to adjust a moisture content to 5.5%. The pH of the material and the initial leaching concentration of fluoride and phosphate are measured according to <Toxicity Leaching Procedure for Solid Wastes—Horizontal Shaking Method> (HJ 557-2010).

According to the proportion of the chemicals for harmlessness, we prepare a powder component consisting of calcium oxide and talc powder (weight ratio 2:1) and a liquid component consisting of poly-aluminum chloride and ferrous sulfate (weight ratio 1:2). According to the initial leaching concentration and the target indicators of the material (pH, fluoride, and phosphate), we shall add 0.6% of the powder component (the chemicals in proportion of the material), and use an ALLU screening bucket for mixing and stirring, that is, flip the ALLU screening bucket back and forth three times to ensure that the powder component is fully mixed with the material. After stirring the material added with the powder component, we use a loader to pile the material into a trapezoidal heap with a height of 0.5 m. During the discharge and transfer process, we spray the liquid component by using an electric sprayer. The proportion of the liquid component is 0.3% (the amount of poly-aluminum chloride and ferrous sulfate in proportion of the material). After transfer and piling, the moisture content reaches 13.6%. We moderately compact the pile by means of an excavator, and cover it with a rainproof tarp for maintenance, next daily take samples to test the leachate of the sample materials according to <Toxicity Leaching Procedure for Solid Wastes-Horizontal Shaking Method> (HJ 557-2010). The test results of the samples on the 2^{nd}, 7^{th}, and 14^{th} day are shown in Table 3.

TABLE 3
Test values of target indicators of the leachate of the materials
before and after harmless treatment in Example 3

| Sample | pH | Phosphate(m/L) | Fluoride(m/L) |
|---|---|---|---|
| Initial | 3.98 | 40.23 | 30.69 |
| 2 d | 7.96 | 0.13 | 6.34 |
| 7 d | 7.79 | 0.15 | 6.03 |
| 14 d | 7.57 | 0.16 | 5.78 |

From Table 3, we find that after adding chemicals, the leachate of phosphogypsum changes from acidic to alkaline on the 2^{nd} day, after 7 days, the concentration of phosphate declines by 99.6%, and the concentration of fluoride declines by 80.4%. In the harmless phosphogypsum, all indicators are below the limit values specified in <Integrated Wastewater Discharge Standard> (GB 8978-1996).

### Example 4

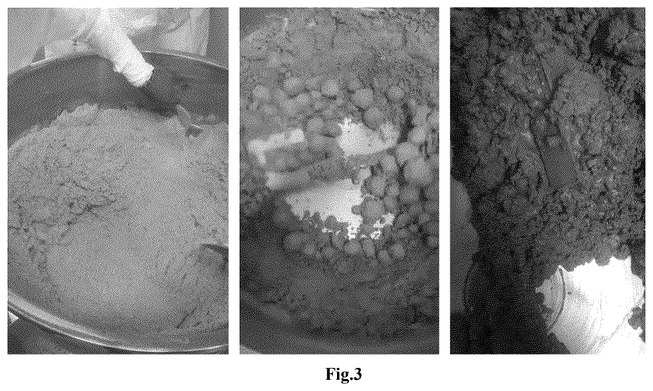

In this example, we mainly investigate the agglomeration and bleeding water of phosphogypsum with different moisture contents during stirring. Among them, the phosphogypsum with a low-moisture content (9.24%) is derived from the superficial layer (0-0.5 m) of the phosphogypsum dried for 65 days; the phosphogypsum with a moderate-moisture content (19.87%) is derived from the superficial layer (0-1 m) of the phosphogypsum dried for 20 days; the phosphogypsum with a high-moisture content (26.32%) is derived from the superficial layer (0-1 m) of the phosphogypsum dried for 3 days. It can be observed that as the moisture content increases, the mixing uniformity worsens, the agglomeration and bleeding water occurs during mixing, as shown in the on-site photos in FIG. 3.

In summary, it can be seen that the creative aspects of the technical solution of the present invention mainly include, but not limited to the following contents.
(1) By compounding and using chemical components with different functions, exerting the synergistic effect of the different components, it is possible to achieve high-efficiently mixing phosphogypsum and the chemicals, ensure sufficient contact and reaction between the chemicals and the pollutants, so as to achieve a better passivation effect at a lower weight ratio for adding chemicals.
(2) According to the different properties and functions of the chemicals, they are divided into a solid-phase component and a liquid-phase component and added stepwise. In addition, their process parameters can be adjusted according to the properties of the chemicals. The decrease in the water content of phosphogypsum at the stage of mixing the solid-phase component makes it easy to evenly mix solids with solids. After evenly mixing solids with solids, the passivation chemicals are evenly added to the phosphogypsum in form of liquid. It is possible to control dust during the production process and simultaneously increase the moisture content to provide the high-moisture conditions needed for the passivation reaction by way of spraying the liquid component, so as to achieve three purposes in one step.
(3) It is possible to develop a targeted engineering application method of stepwise adding chemicals and stepwise controlling, so as to form a complete set of phosphogypsum modification processes that includes chemicals, an engineering application method, and a device.

It should be noted that in the present invention, unless otherwise understood from the entire text, an expression of “A/B” should be interpreted as any one of the following three concurrent situations: A, B, A and B.

It should also be noted that, in the present invention, unless otherwise understood from the entire text, if applicable, a relevant term should be understood as follows. Relational terms such as first and second are merely used to distinguish one entity or operation from another, and do not necessarily require or imply the existence of any actual relationship or sequence between such entities or operations. Moreover, the terms “including”, “comprising” or any other variations thereof mean non-exclusive inclusion, so that a process, method, article, or apparatus that includes a series of elements not only includes those elements but also includes other elements not explicitly listed, or elements that are inherent to such a process, method, article, or apparatus. Without additional limitations, an element defined by the phrase “including a . . . ” does not exclude the presence of an additional identical element in a process, method, article, or apparatus that includes the said element.

Although the present invention has been disclosed above through the description of specific embodiments of the present invention, it should be understood that a person skilled in the art can make various modifications, improvements, or equivalents to the present invention within the essence and scope of the claims. These modifications, improvements, or equivalents should also be deemed to be included within the protection scope as claimed by the present invention.

What is claimed is:

1. A harmless-treatment chemical agent for phosphogypsum consisting of a powder component and a liquid component,
wherein the powder component consists of an alkaline component and talc powder, and the alkaline component is at least one of calcium oxide, magnesium oxide, calcium hydroxide and magnesium hydroxide; the liquid component is an aqueous solution of at least one of a soluble iron salt, a soluble aluminum salt and a soluble calcium salt;
wherein in the powder component, a weight ratio of the alkaline component to the phosphogypsum to be treated is 0.2%˜1.0%; a weight ratio of the talc powder to the phosphogypsum to be treated is 0.1%˜0.6%; a weight ratio of the liquid component, calculated as solids, to the phosphogypsum to be treated is 0.2˜0.6%.

2. The harmless-treatment chemical agent for phosphogypsum according to claim 1, wherein the soluble aluminum salt includes at least one of aluminum sulfate, aluminum chloride and poly-aluminum chloride;
the soluble iron salt includes at least one of ferric sulfate, ferric chloride, ferrous sulfate and poly-ferric sulfate;
the soluble calcium salt is calcium chloride.

3. The harmless-treatment chemical agent for phosphogypsum according to claim 1, wherein in the powder component, a weight ratio of the alkaline component to the talc powder is 2˜5:1.

4. The harmless-treatment chemical agent for phosphogypsum according to claim 3, wherein the powder component consists of calcium oxide with a weight ratio of 0.40% in proportion of the phosphogypsum to be treated, magnesium oxide with a weight ratio of 0.10% in proportion of the phosphogypsum to be treated, and talc powder with a weight ratio of 0.10% in proportion of the phosphogypsum to be treated, and the liquid component consists of aluminum sulfate with a weight ratio of 0.15% in proportion of the phosphogypsum to be treated and ferric chloride with a weight ratio of 0.10% in proportion of the phosphogypsum to be treated;
or wherein the powder component consists of calcium oxide with a weight ratio of 0.48% in proportion of the phosphogypsum to be treated and talc powder with a weight ratio of 0.12% in proportion of the phosphogypsum to be treated, and the liquid component is polymeric alumina with a weight ratio of 0.40% in proportion of the phosphogypsum to be treated;
or wherein the powder component consists of calcium oxide with a weight ratio of 0.40% in proportion of the phosphogypsum to be treated and talc powder with a weight ratio of 0.20% in proportion of the phosphogypsum to be treated, and the liquid component consists of poly-ferric chloride with a weight ratio of 0.10% in proportion of the phosphogypsum to be treated and ferrous sulfate with a weight ratio of 0.20% in proportion of the phosphogypsum to be treated.

5. The harmless-treatment chemical agent for phosphogypsum according to any one of claims 1-4, wherein a divergence between distributions of the particle size of the alkaline component and the particle size of the phosphogypsum to be treated is not more than +5%, and a content of active ingredients of the alkaline component is not less than 80%, and fineness of the talc powder is not less than 400 mesh.

6. An engineering application method of a harmless-treatment chemical agent for phosphogypsum consisting of a powder component, which consists of an alkaline component selected from at least one of calcium oxide, magnesium oxide, calcium hydroxide and magnesium hydroxide, and talc powder, and a liquid component, which is an aqueous solution of at least one of a soluble iron salt, a soluble aluminum salt and a soluble calcium salt; comprising:
S1 a step of pretreating phosphogypsum, including the processes of breaking and sieving phosphogypsum into a particle size of 1-5 mm, meanwhile adjusting a content of adsorbed water to 5-10%, so as to obtain pretreated phosphogypsum;
S2 a step of adding a powder component, including the process of mixing evenly the pretreated phosphogypsum obtained in step S1 with the powder component of the harmless-treatment chemical agent for phosphogypsum, so as to obtain a mixture;
S3 a step of adding a liquid component, including the processes of adding the liquid component of the harmless-treatment chemical agent for phosphogypsum to the mixture obtained in step S2, and adjusting a content of adsorbed water to 12-20%, so as to obtain a material; and
S4 a step of maintenance and preparation for inspection, including the processes of piling the material obtained in step S3 for maintenance and maintaining moisture of the material to enable sufficient reaction, then carrying out comprehensive utilization as needed after achievability to a standard.

7. The engineering application method of a harmless-treatment chemical agent for phosphogypsum according to claim 6, wherein the soluble aluminum salt includes at least one of aluminum sulfate, aluminum chloride and poly-aluminum chloride;
the soluble iron salt includes at least one of ferric sulfate, ferric chloride, ferrous sulfate and poly-ferric sulfate;
the soluble calcium salt is calcium chloride.

8. The engineering application method of a harmless-treatment chemical agent for phosphogypsum according to claim 6, wherein in the powder component, a weight ratio of the alkaline component to the phosphogypsum to be treated is 0.2%˜1.0%; a weight ratio of the talc powder to the phosphogypsum to be treated is 0.1%˜0.6%; a weight ratio of the liquid component, calculated as solids, to the phosphogypsum to be treated is 0.2˜0.6%.

9. The engineering application method of a harmless-treatment chemical agent for phosphogypsum according to claim 8, wherein in the powder component, a weight ratio of the alkaline component to the talc powder is 2˜5:1.

10. The engineering application method of a harmless-treatment chemical agent for phosphogypsum according to claim 9, wherein the powder component consists of calcium oxide with a weight ratio of 0.40% in proportion of the phosphogypsum to be treated, magnesium oxide with a weight ratio of 0.10% in proportion of the phosphogypsum to be treated, and talc powder with a weight ratio of 0.10% in proportion of the phosphogypsum to be treated, and the liquid component consists of aluminum sulfate with a weight ratio of 0.15% in proportion of the phosphogypsum to be treated and ferric chloride with a weight ratio of 0.10% in proportion of the phosphogypsum to be treated;
or wherein the powder component consists of calcium oxide with a weight ratio of 0.48% in proportion of the phosphogypsum to be treated and talc powder with a weight ratio of 0.12% in proportion of the phosphogypsum to be treated, and the liquid component is polymeric alumina with a weight ratio of 0.40% in proportion of the phosphogypsum to be treated;
or wherein the powder component consists of calcium oxide with a weight ratio of 0.40% in proportion of the phosphogypsum to be treated and talc powder with a weight ratio of 0.20% in proportion of the phosphogypsum to be treated, and the liquid component consists of poly-ferric chloride with a weight ratio of 0.10% in proportion of the phosphogypsum to be treated and ferrous sulfate with a weight ratio of 0.20% in proportion of the phosphogypsum to be treated.

11. The engineering application method of a harmless-treatment chemical agent for phosphogypsum according to any one of claims 6-10, wherein a divergence between distributions of the particle size of the alkaline component and the particle size of the phosphogypsum to be treated is not more than +5%, and a content of active ingredients of the alkaline component is not less than 80%, and fineness of the talc powder is not less than 400 mesh.

12. The engineering application method of a harmless-treatment chemical agent for phosphogypsum according to any one of claims 6-10, wherein in step S3, the process of adding the liquid component during discharging or transferring the mixture obtained in step S2 is executed by means of spraying.

13. The engineering application method of a harmless-treatment chemical agent for phosphogypsum according to claim 12, wherein in step S4, the surface of the material is coated with a layer of matter, which may be a plastic film, a HDPE film, a non-woven fabric or a plant straw, so as to maintain moisture of the material.

14. The engineering application method of a harmless-treatment chemical agent for phosphogypsum according to any one of claims 6-10 and 13, wherein in step S4, the process of piling the material is executed for 2-14 days.
